(19) United States
(12) Patent Application Publication
(10) Pub. No.: US 2025/0072662 A1
(43) Pub. Date: Mar. 6, 2025

(54) OUTDOOR COOKING STATION, SIDE SHELF SYSTEM, AND METHOD THEREOF

(71) Applicant: North Atlantic Imports, LLC, Logan, UT (US)

(72) Inventors: Tyler J. Fullmer, Smithfield, UT (US); Tyson K. Holmstead, Logan, UT (US); Dillon S. McGrew, North Logan, UT (US)

(21) Appl. No.: 18/823,662

(22) Filed: Sep. 3, 2024

Related U.S. Application Data
(60) Provisional application No. 63/536,678, filed on Sep. 5, 2023.

(51) Int. Cl. A47J 37/07

(52) U.S. Cl. CPC A47J 37/0786; A47J 2037/0795

(57) ABSTRACT

A side shelf system associated with a cooking station is provided. The side shelf system includes a side shelf and an insert, such as a cutting board, the side shelf defining a recess therein sized and configured to retain the insert. The side shelf system may be pivotably coupled to the cooking station such that the side shelf system may be moved between a use position and a pivoted position. The insert is sized and configured to be slide into or be removed from the insert in a direction parallel to an upper surface of the side shelf such that the recess is defined by containment structure. Further, the insert may slide to and from the front side of the side shelf. With this arrangement, upon the side shelf system being in the pivoted position, the insert is maintained within the side shelf via the containment structure.

### CROSS-REFERENCE TO RELATED APPLICATIONS

This application claims the benefit of U.S. Provisional Application No. 63/536,678, filed Sep. 5, 2023, the disclosure of which is hereby incorporated by reference herein in its entirety.

### TECHNICAL FIELD

The present invention relates generally to outdoor cooking stations and, more specifically, the present invention relates to a side shelf system for outdoor cooking stations.

### BACKGROUND

Barbequing has become a popular and pervasive tradition in much of the world. A barbeque grill is a device for cooking food by applying heat directly below a grill. There are several varieties of grills but most fall into one of two categories, either gas fueled or charcoal. Gas fueled grills typically use propane or natural gas as a fuel source, with the gas flame either cooking the food directly or heating grilling elements which in turn radiate the heat necessary to cook the food. Grilling has become a popular method of cooking food due to the unique flavors and texture imparted to the food during the grilling process.

A griddle is a cooking device consisting of a broad flat surface that can be heated using a variety of means and is used in both residential and commercial applications for a variety of cooking operations. The griddle is most commonly a flat metal plate composed of cast or wrought iron, aluminum or carbon steel. Griddles are commonly heated directly or indirectly by open flame or electrical elements. Using a griddle placed directly on a barbeque grill or over flame burners has also become popular when cooking foods not as well suited for cooking directly on a grill over an open flame.

Griddles are often employed for cooking large quantities of food. Managing the food properly, especially in an outdoor setting, often becomes problematic while also maintaining a clean cooking area. Managing the limited space available for the food and waste while cooking is also challenging. As such, it would be advantageous to provide a portable outdoor cooking station, or the like, that limits the challenges while cooking in an outdoor setting.

### BRIEF SUMMARY OF THE INVENTION

The present invention is directed to various embodiments of a side shelf or side shelf system. For example, in one embodiment, a side shelf system for coupling to a portable outdoor cooking station is provided. The side shelf system includes a side shelf and an insert. The side shelf includes a main wall, a front side wall, a rear side wall, an outer side wall and an inner side wall, the inner side wall sized and configured to be pivotably coupled to the cooking station such that the side shelf is moveable between a use position and a pivoted position. The main wall extends to define a recess therein such that, upon the side shelf being in the use position, the main wall extends to define an upper surface and an underside surface. The underside surface includes a wall extending directly downward from the underside surface and adjacently along portions of the recess so as to be set-back from a free end of the main wall that defines the recess. The wall includes a ledge extending from the wall such that the ledge extends inward to extend substantially parallel with the underside surface of the main wall and adjacently below the free end. The insert is sized and configured to be positioned within the recess so as to be positioned over the ledge and below the free end of the main wall. With this arrangement, the insert is configured to be slidably removed from the side shelf in a direction parallel with the upper surface.

In another embodiment, the side shelf is configured to facilitate the insert being removed from, or inserted into, the recess along a single side of the side shelf. In another embodiment, the front side wall is the single side of the side shelf.

In another embodiment, the recess is sized and configured to retain the insert in the use position and the pivoted position. In still another embodiment, upon the insert being positioned in the recess, the ledge and the main wall are positioned along opposite sides of the insert. In yet another embodiment, the insert is at least one of a cutting board and a bin.

In accordance with another embodiment of the present invention, a cooking station with a retaining feature is provided. The cooking station includes a main body, a side shelf and an insert. The main body includes a framework and panels extending between an upper side and a lower side, the main body configured to support one or more heating elements therein for heating a cooking surface supported adjacent the upper side of the main body. The side shelf includes a main wall, a front side wall, a rear side wall, an outer side wall and an inner side wall, the inner side wall sized and configured to be pivotably coupled to the cooking station such that the side shelf is moveable between a use position and a pivoted position. The main wall extends to define a recess therein such that, upon the side shelf being in the use position, the main wall extends to define an upper surface and an underside surface. The underside surface includes a wall extending directly downward from the underside surface and adjacently along portions of the recess so as to be set-back from a free end of the main wall that defines the recess. The wall includes a ledge extending from the wall such that the ledge extends inward to extend substantially parallel with the underside surface of the main wall and adjacently below the free end. The insert is sized and configured to be positioned within the recess so as to be positioned over the ledge and below the free end of the main wall, the insert configured to be slidably removed from the side shelf in a direction parallel with the upper surface.

In another embodiment, the side shelf is configured to facilitate the insert being removed from, or inserted into, the recess along a single side of the side shelf. In a further embodiment, the front side wall is the single side of the side shelf.

In another embodiment, the recess is sized and configured to retain the insert in the use position and the pivoted position. In another embodiment, upon the insert being positioned in the recess, the ledge and the main wall are positioned along opposite sides of the insert. In still another embodiment, the insert is at least one of a cutting board and a bin.

In accordance with another embodiment of the present invention, a method for retaining portions of a side shelf system is provided. The method includes the steps of: providing an outdoor cooking station with a main body, the main body including a side shelf coupled thereto, the side shelf defining an upper side and a lower side, the upper side including a recess defined therein, the recess extending from the upper side to the lower side to define containment walls; and sliding an insert into the recess in a direction parallel to the upper side of the side shelf and along a front side of the side shelf such that the containment walls retain the insert within the recess, upon the side shelf being moved between a use position and a pivoted position.

In another embodiment, the method step of sliding includes moving the insert between a ledge and the upper side of the side shelf such that the ledge and upper side of the side shelf is positioned along opposite sides of the insert. In another embodiment, the method step of sliding includes removing or inserting the insert into the recess along a single side of the side shelf. In another embodiment, the method further includes the step of pivoting the side shelf to a pivoted position while maintaining the insert in the recess of the side shelf. In another embodiment, the step of sliding includes positioning a flange portion of a bin within the recess of the side shelf. In another embodiment, the method step of sliding includes positioning at least one of a cutting board and a bin at least partially within the recess of the side shelf.

In accordance with another embodiment of the present invention, a shelf system with a retaining feature is provided. The shelf system includes a side shelf having an upper side and a lower side, a recess, and a removable insert. The upper side and lower side of the side shelf extend to a front side, a rear side, a left side, and a right side. The recess is defined in the upper side of the side shelf and extends towards the lower side of the side shelf. The removable insert is sized and configured to be positioned within the recess.

In another embodiment, the insert positioned within the recess is enclosed therein on a rear edge, a left edge, and a right edge of the recess such that the insert is contained therein. In another embodiment, a front side of the side shelf is configured to be open and allow for the insert to slide into and from the recess defined in the side shelf.

In another embodiment, the recess defined in the shelf includes containment walls extending from the upper side to the lower side of the shelf, the containment walls configured to guide the insert into the recess and hold it in position. In a further embodiment, the containment walls include a rear wall, a left wall, a right wall, and a lower wall, the lower wall being coupled to and extending perpendicular to the rear wall, left wall, and right wall. In yet another embodiment, the upper side of the shelf system extends partially over the insert such that the upper side is configured to hold the insert within the recess between the upper side and a lower wall of the recess. In another embodiment, the insert is a cutting board or a bin.

In accordance with another embodiment of the present invention, a cooking system with a retaining feature is provided. The cooking system includes a main body of an outdoor cooking station, a side shelf, and a removable insert. The side shelf is sized and configured to be coupled to the main body. The side shelf defines an upper side and a lower side, the upper side and lower side extending to a front side, rear side, left side, and right side of the side shelf. The side shelf includes a recess defined therein, the recess extending from the upper side to the lower side to define containment walls. The removable insert is sized and configured to be positioned within the recess such that the containment walls hold the insert within the recess.

In another embodiment, the recess is enclosed on a rear edge, a left edge, and a right edge such that the insert is maintained within the recess. The front side of the recess is configured to be open and allow for the insert to be positioned within the recess. In another embodiment, the containment walls are configured to guide the insert into the recess and hold it in position. In another embodiment, the containment walls are defined by a rear wall, a left wall, a right wall, and a lower wall, the lower wall coupled to and extends perpendicular to the rear wall, left wall, and right wall. In another embodiment, the upper side of the shelf extends partially over the insert such that the upper side is configured to hold the insert within the recess between the upper side and a lower wall of the recess. In another embodiment, the insert is a cutting board or a bin. In another embodiment, the side shelf is configured to be pivotably coupled to the main body, such that, the side shelf pivots from a compact position and a use position such that the upper side of the side shelf and containment walls of the recess hold the insert within the recess when the side shelf is in the compact position.

In accordance with another embodiment of the present invention, a method for preparing food on an outdoor cooking system is provided. The method steps include: providing an outdoor cooking station with a main body, the main body including a side shelf coupled thereto, the side shelf defining an upper side and a lower side, the upper side including a recess defined therein, the recess extending from the upper side to the lower side to define containment walls; retaining a removable insert in the recess such that the containment walls retain the insert within the recess, upon the side shelf being moved to either a use position or a pivoted position, the upper side extending over a portion of an insert periphery further securing the insert therein; and preparing a food item on the removable insert.

In another embodiment, the method further includes pivoting the side shelf to the pivoted position such that the upper side extends generally perpendicular to a ground surface and the insert is continuously secured by the containment walls of the recess and the upper side of the side shelf.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is a perspective view of a cooking station with a side shelf, according to an embodiment of the present invention;

FIG. 1A is an exploded view of the cooking station, according to another embodiment of the present invention;

FIG. 2 is a partially exploded view of the cooking station, depicting an insert removed from the side shelf of the cooking station, according to another embodiment of the present invention;

FIG. 3 is a perspective view of the cooking station, depicting the cooking station with the side shelf in a compact position, according to another embodiment of the present invention;

FIG. 4 is a lower perspective view of the side shelf, depicting the insert positioned within an opening defined in the side shelf, according to another embodiment of the present invention;

FIG. 5 is a top view of the side shelf, depicting the insert positioned within the opening defined in the side shelf, according to another embodiment of the present invention;

FIG. 6 is a cross-sectional view of the side shelf taken along line 6-6 of FIG. 5, according to another embodiment of the present invention;

FIG. 7 is a perspective view of the side shelf, depicting the insert positioned in the opening of the side shelf, according to another embodiment of the present invention;

FIG. 8 is a perspective view of the side shelf, depicting the insert partially positioned within and slideable from the opening of the side shelf, according to another embodiment of the present invention; and

FIG. 9 is a perspective view of the side shelf, depicting the insert removed from the opening of the side shelf defined thereon, according to another embodiment of the present invention.

### DETAILED DESCRIPTION OF THE INVENTION

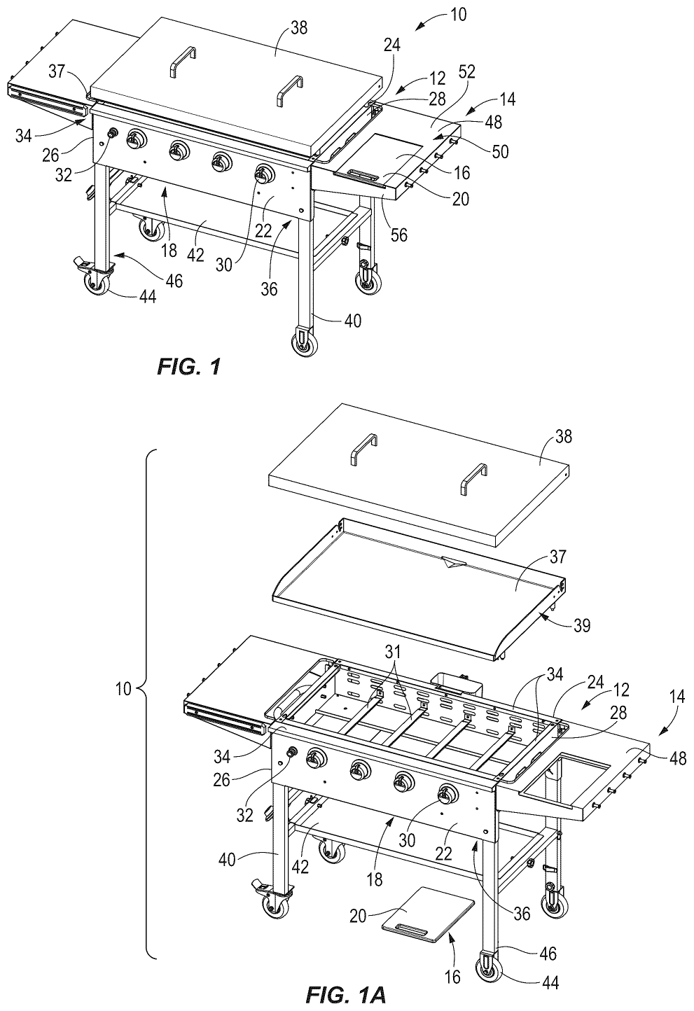

Referring to FIGS. 1, 1A, 2, and 3, a cooking station 10 including a main body 12 and a side shelf system 14 is provided. Such cooking station 10 may be configured to be compactable and portable such that when the cooking station 10 is in a compact configuration the side shelf system 14 may retain and hold an insert 16 therewith. The cooking station 10 may include the main body 12 extending with frame components and multiple panels 18 where at least one of two opposing sides may include the side shelf system 14 coupled thereto. The side shelf system 14 may be pivotable between a use position and a compact position, the use position having a preparation surface 20 extending horizontal and the compact position having the preparation surface 20 extending generally vertical. The side shelf system 14 may also be configured to facilitate readily removing unwanted or uncooked food from the preparation surface 20 by configuring the insert 16 to be removable. Further, the insert may be partially removable when removing unwanted or uncooked food from the insert.

As previously stated, the cooking station 10 may include the main body 12 with multiple panels 18 to define a front panel 22, a rear panel 24, a left panel 26, and a right panel 28. The front panel 22 and rear panel 24 may extend substantially parallel to one another on opposing sides of the main body 12. Further, the front panel 22 may be coupled to the left panel 26 and right panel 28 adjacent to opposing ends of the front panel 22. Similarly, the rear panel 24 may also be coupled to the left panel 26 and the right panel 28 adjacent to opposing ends of the rear panel 24. The left panel 26 and right panel 28 may extend substantially parallel to one another and substantially perpendicular to the front panel 22 and rear panel 24. As such, the front panel 22, the rear panel 24, the left panel 26, and the right panel 28 may extend to define an interior of the main body 12. Further, the front panel 22, the rear panel 24, the left panel 26 and the right panel 28 may correspond with respective front, rear, left and right sides of the main body 12. The main body 12 may be the framework for holding and supporting functional components of the cooking station 10, such as burners, gas lines, various valves and other functional mechanical and/or electrical components to functionally employ the cooking station 10, as known to one of ordinary skill in the art. Further, the front panel 22 may include burner knobs 30 configured to allow fuel, such as propane or natural gas, to flow to burners 31 positioned within the interior of the main body 12. Even further, the front panel 22 of the main body 12 may include an ignitor 32 sized and configured to ignite fuel at the burners 31 of the cooking station 10. In some embodiments, the ignitor 32 may be coupled to the burner knobs 30 such that the ignitor 32 may be configured to light the fuel flowing through the burners 31, upon turning one of the burner knobs 30 to an on or open position.

The front panel 22, the rear panel 24, the left panel 26, and the right panel 28 may extend to define an upper periphery 34 and lower periphery 36 of the main body 12. The upper periphery 34 may be configured to support a cooking surface 37, such as a griddle 39, to be positioned on or over the upper periphery 34 of the main body 12. As previously stated, the ignitor 32 may ignite the fuel such that a flame is produced flowing from the burners, where the flame may heat the cooking surface 37 positioned on the upper periphery 34 of the main body 12. The cooking station 10 may also include a hood 38 sized and configured to be positioned over the cooking surface 37. In some embodiments, the hood 38 may be pivotably coupled to the main body 12 or the cooking surface 37, such as a griddle 39. The lower periphery 36 of the main body 12 may include legs 40 that may extend from the main body 12 toward the ground or floor surface. In one embodiment, the legs 40 may be pivotably coupled to the lower periphery 36 of the main body 12 such that the legs 40 may move between a use, upright position and a folded, compact position. Further, the legs 40 may include a lower shelf 42 positioned between the legs 40. In one embodiment, the lower shelf 42 may provide stability to the legs 40 such that the lower shelf 42 is configured to keep the legs 40 from pivoting inward towards the main body 12. The legs 40 may also include wheels 44 positioned at a bottom end 46 of the legs 40, the wheels 44 assisting in the portability of the cooking station 10.

As previously set forth, the left panel 26 and/or the right panel 28 may include the side shelf system 14 coupled adjacent thereto. The side shelf system 14 may be pivotably coupled such that the side shelf system 14 may pivot between the use position and the compact position. The use position may correlate with the side shelf system 14 extending perpendicular to the left panel 26 and right panel 28, such that, the side shelf system 14 may provide a usable shelf surface 48. The compact position may correlate to the side shelf system 14 extending substantially parallel to the left panel 26 and right panel 28, extending towards the ground for which the cooking station 10 may be positioned upon. In this manner, the shelf surface may be pivotable between the use position and the compact pivoted position.

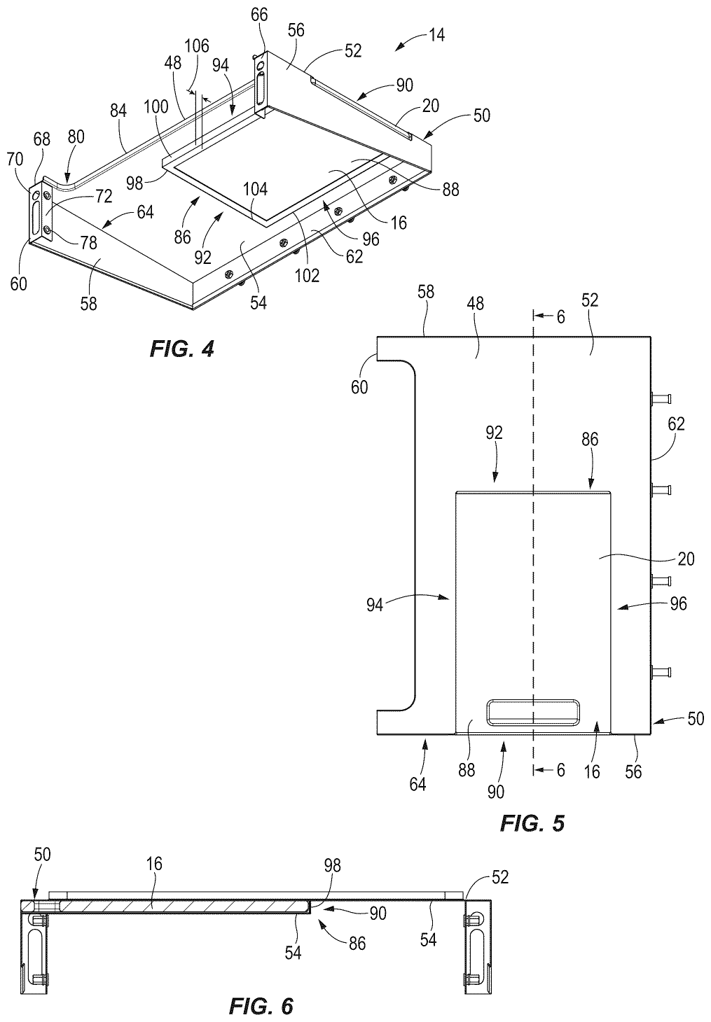

Now with reference to FIGS. 1 and 4, the side shelf system 14 may be defined by a side shelf 50 and the insert 16. The side shelf 50 may extend to define an upper side 52, a lower side 54, a front side 56, a rear side 58, a left side 60, and a right side 62. The upper side 52 of the side shelf 50 may also include the shelf surface 48 of the side shelf system 14, as previously set forth. The side shelf system 14 may be positioned on, or adjacent to, the left panel 26 and/or the right panel 28. The left side 60 and right side 62 may mirror one another upon the side shelf system 14 being positioned on both the left panel 26 and the right panel 28, each of which may include similar features and description.

With reference to FIGS. 3-6, the front side 56, rear side 58, left side 60, and right side 62 of the side shelf 50 may extend from a periphery 64 of the upper side 52 and lower side 54, such that the front side 56, rear side 58, left side 60, and right side 62 may extend perpendicular to the upper side 52 and lower side 54 of the side shelf 50. The front side 56 and rear side 58 may extend parallel to one another. The front side 56 of the side shelf 50 may be coupled to, and extend from, the left side 60 and right side 62 on opposing ends of the front side 56. Similarly, the rear side 58 of the side shelf 50 may be coupled to, and extend from, the left side 60 and the right side 62 on opposing ends of the rear side 58. Further, the front side 56 and rear side 58 may extend perpendicular to the left side 60 and right side 62 of the side shelf 50. Similar to the front side 56 and rear side 58, the left side 60 and right side 62 may extend generally parallel to one another, or portions thereof may extend parallel to each other. The left side 60, being coupled adjacent to the right panel 28 of the main body 12, may extend to define a first end 66 and a second end 68. The first end surface 66 and second end surface 68 may each include a left face 70 and an inward face 72. The left face 70 of each the first and second ends 66, 68 may face towards the right panel 28 and extend perpendicular to the front side 56 and rear side 58. The inward face 72 of the first and second ends 66, 68 may face towards the rear side 58 or towards the front side 56 for the first end 66 and second end 68, respectively, such that the inward face 72 may extend parallel to the front side 56 and rear side 58. The right panel 28 of the main body 12 may include brackets 74 extending therefrom, the brackets sized and configured for the side shelf system 14 to be pivotably coupled thereto. The inward face 72 of the first end 66 and second end 68 of the left side 60 may be coupled to the brackets 74 by way of a pin 76 extending through a pin hole 78 positioned on the inward face 72. The pin 76 and pin hole 78 may be sized and configured to allow for the side shelf system 14 to pivot from the use position to the compact position or folded position.

With reference to FIG. 4, in one embodiment, the front side 56 and rear side 58 may extend with a taper from the left side 60 to the right side 62 of the side shelf 50. As such, the front side 56 and rear side 58 may have a height taller at the coupling of the left side 60 than the coupling of the right side 62. In one embodiment, front side 56, rear side 58, and right side 62 may extend continuously around the periphery 64 of the upper side 52 and lower side 54 of the side shelf 50, where, the left side 60 may not extend continuously from the first end 66 to the second end 68. In this configuration, the left side 60 may open up the right panel 28 to the lower side 54 of the side shelf 50.

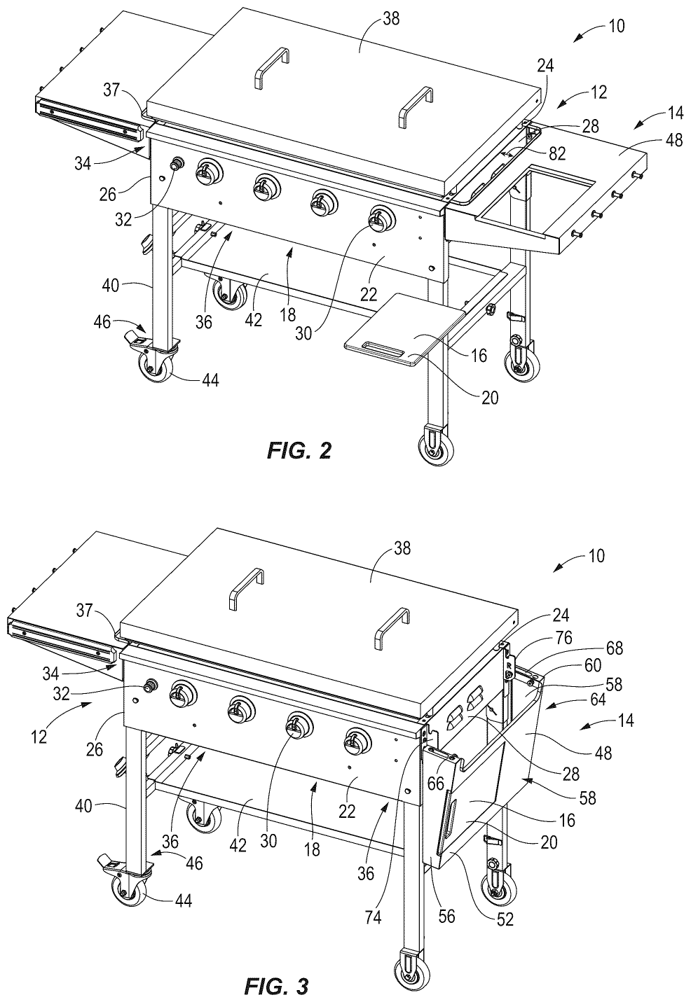

With reference to FIGS. 4 and 5, the upper side 52 may extend to define the periphery 64, extending to the front side 56, rear side 58, left side 60, and right side 62. The periphery 64 of the upper side 52 may define an elongated opening 80 along the left side 60. The side shelf system 14, being in the use position, may extend with the elongated opening 80 positioned adjacent the right panel 28 of the main body 12. The elongated opening 80 may also include an upstanding ridge 84 extending along a length (including along curved portion) of the elongated opening 80. Such elongated opening extends to define a gap 82 adjacent the main body 12 (FIG. 2) and adjacent the griddle 39 (FIG. 1A). The gap 82 created by the elongated opening as well as the elongated ridge 84 facilitates a safety feature incorporated in the side shelf system 14, which assists in preventing users of the cooking station 10 from placing items too close to a heat zone adjacent the side shelf 50 that is created by the burners 31 along a periphery of the griddle 39 (see FIG. 1A). This feature incorporated in a side shelf is disclosed in commonly assigned U.S. Pat. No. 10,779,682, filed Mar. 25, 2019, the contents of which are incorporated by reference herein in its entirety.

In another embodiment, the upper side 52 of the side shelf 50 may extend to a recess 86 defined therein. The recess 86 may be sized and configured for the insert 16 to be positioned therein, where the insert may be, for example, a cutting board 88 or a bin. A Similar side shelf with a recess or opening defined in the side shelf is disclosed in commonly assigned U.S. Pat. No. 10,888,193, filed Mar. 27, 2019, the contents of which are incorporated by reference herein in its entirety.

The insert 16 as the cutting board 88 may include the preparation surface 20, which preparation surface may be on both or opposite sides of the cutting board 88. In one embodiment, the preparation surface 20 may extend within the same plane as the shelf surface 48 or upper side 52 of the side shelf 50 when the insert 16 is positioned within the recess 86 such that the preparation surface 20 may be somewhat flush with the upper side 52 of the side shelf 50 or be disposed slightly below the upper side 52. The preparation surface 20 of the cutting board 88 may be readily employed for preparing food, such as food to be cut, cored, chopped, peeled, and/or seasoned. In another embodiment, the insert 16 may be a bin. The bin may include an outward extending flange and a container portion, the container portion configured to contain food or anything else desired by the user and the flange configured to be positioned in the recess 86. In another embodiment, the insert 16 may be a combination of the cutting board 88 and bin positioned within the recess 86, such that, the bin may be positioned below the cutting board 88. The cutting board 88 may be partially removed from the recess 86 such that unwanted or unused food may be pushed from the preparation surface 20 and into a bin positioned below or within a waste bag positioned below the side shelf 50.

The recess 86 may extend to define a front recess side 90, a rear recess side 92, a left recess side 94, and a right recess side 96. The front recess side 90 of the recess 86 may be positioned on the periphery 64 of the side shelf 50 extending along a portion of the front side 56 of the side shelf 50. The rear recess side 92 of the recess 86 may extend adjacent and parallel to the front recess side 90 of the recess 86 as well as extend parallel to the rear side 58 of the side shelf 50. The left recess side 94 and right recess side 96 of the recess 86 may extend perpendicular to the front recess side 90 and the rear recess side 92 of the recess 86 and parallel to the left side 60 and right side 62 of the side shelf 50. The recess 86 may extend over a portion of the upper side 52 of the side shelf 50 such that the recess 86 may extend from the front side 56 towards the rear side 58 of the side shelf 50, or, the recess 86 may extend over a portion of the shelf surface 48.

With reference to FIGS. 4, 5, and 6, the recess 86 may extend from the upper side 52 to the lower side 54 of the side shelf 50 so as to define a wall and a ledge. For example, the wall may extend to define a rear wall 98, left wall 100, right wall 102, and lower wall 104, the lower wall 104 being the ledge. The rear wall 98, left wall 100, right wall 102, and lower wall 104 (or ledge) may be sized and configured to contain the insert 16 within the recess 86. As such, the walls defining the recess may hold the insert 16 therein so that the insert 16 may not inadvertently or readily fall-out from the recess defined in the side shelf 50, upon the side shelf 50 being positioned in the folded-down or compact position. The rear wall 98, left wall 100, and right wall 102 may extend along the rear recess side 92, left recess side 94, and right recess side 96 of the recess 86, respectively. The rear wall 98 of the recess 86 may extend parallel to the rear side 58 of the side shelf 50 and be coupled to the lower side 54 of the side shelf 50 such that the rear wall 98 may extend perpendicular therefrom. Similarly, the left wall 100 and right wall 102 may extend parallel to the left side 60 and right side 62 of the side shelf 50 and may be parallel to one another, and be coupled to (or extend from) the lower side 54 of the side shelf 50 such that the left wall 100 and right wall 102 may extend perpendicular therefrom. The rear wall 98 may also be coupled to the left wall 100 and right wall 102 and extend therebetween. The rear wall 98, left wall 100, and right wall 102 may also be coupled to the lower wall 104 of the recess 86. The lower wall 104 may extend parallel to the lower side 54 (or underside) of the side shelf 50 and perpendicular to the rear wall 98, left wall 100, and right wall 102. The lower wall 104 may be sized and configured for the insert 16 to be set thereon or to hold the insert 16 within the recess 86, upon the side shelf 50 being in the use position or horizontal position. The rear wall 98, left wall 100, and right wall 102 may extend with a height similar or partially larger than that of the thickness or depth of the insert 16 such that the insert 16 may snugly fit within the recess 86. In one embodiment, the lower wall 104 may extend inwards from the rear wall 98, left wall 100, right wall 102, and front 90 of the recess 86 with a width 106, such that, the insert 160 may be exposed along the lower side 54 of the side shelf 50. In another embodiment, the lower wall 104 may extend across a lower side of the side shelf 50 such that the insert 16 may not be exposed along the lower side of the side shelf 50.

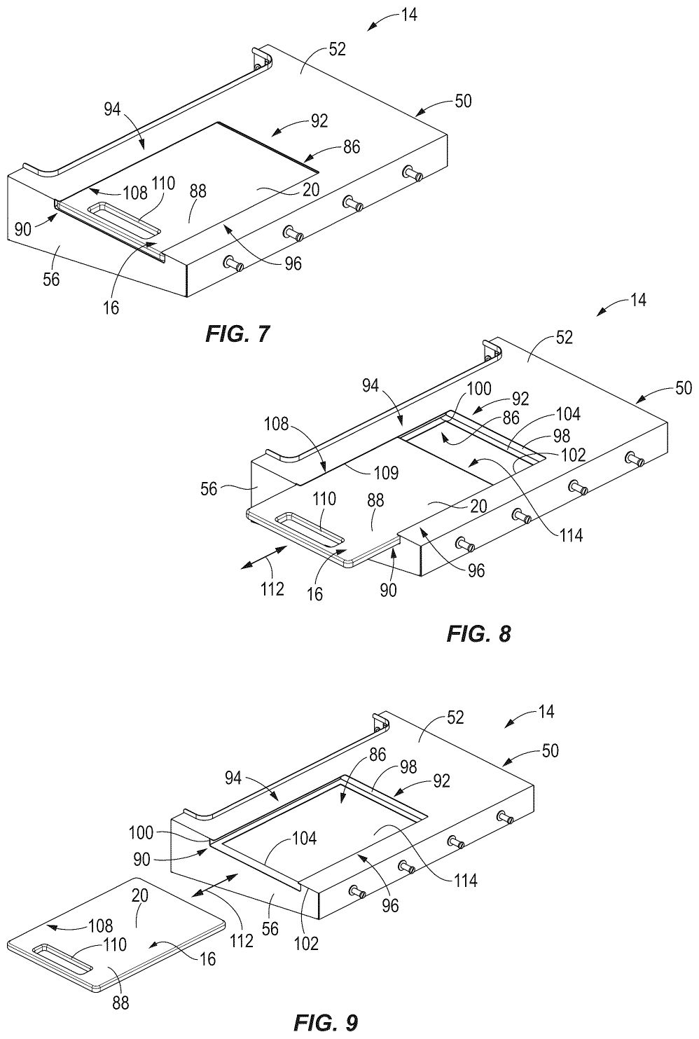

Now with reference to FIGS. 7 and 8, as previously provided, the insert 16 may be the cutting board 88 sized and configured to fit and be held within the recess 86 defined in the side shelf 50. The rear wall 98, left wall 100, right wall 102, and lower wall 104 are configured to hold and retain the insert 86 within the recess 86. The upper side 52 of the side shelf 50 may extend over the recess 86 to define an insert periphery 108. Such insert periphery 108 may be a flange structure extending to a free end 109 that may extend slightly over the preparation surface 20 of the cutting board 88 or other such insert 16, such that, the upper side 52 or insert periphery 108 may be configured to assist in holding the insert 16 within the recess 86. As such, the lower wall 104 and flange of the upper side may extend over respective opposite sides of the insert 16. In other words, the insert 16 may be positioned between the lower wall 104 and the flange extending to the free end 109. Further, the upper side 52 may extend partially over the recess 86 adjacent the rear recess side 92, left recess side 94, and right recess side 96 of the recess 86, such that, the rear recess side 92, left recess side 94, and right recess side 96 of the recess 86 may at least partially enclose the insert 16 in the recess 86 with the upper side 52 of side shelf 50. In this manner, with the insert 16 being positioned within the recess 86, the upper side 52 of the side shelf 50 may retain the insert 16 within the recess 86, upon the side shelf system 14 being pivoted from the use position (FIG. 1) to the compact position (FIG. 2).

Now with FIGS. 7, 8, and 9, as previously set forth, the upper side 52 or insert periphery 108 of the side shelf 50 may extend partially over the recess 86 (or over the insert 16) so as to hold the insert 16 within the recess 86. In one embodiment, the recess 86 defined in the side shelf 50 may include each of the rear wall 98, left wall 100, and right wall 102, but not include a wall along the front recess side 90 of the recess. In another embodiment, the recess 86 defined in the side shelf 50 may include the left wall 100 and the right wall 102, but not include a wall along the front recess side 90 as well as along a rear recess side 92. In another embodiment, the recess 86 defined in the side shelf may include the left wall and the right wall, but include a wall adjacent the front recess side 90, but not along the rear recess side 92. In each of these embodiments, the insert 16 may be held within the recess 86 defined in the side shelf 50 and, if desired, be manually removed from the side shelf 50 by sliding the insert 16 from the recess 86. For example, the front recess side 90 of the recess 86 may allow for access to the insert 16 such that the insert 16 may be positioned within and removed from the recess 86 by sliding the cutting board 88 from the recess 86, as depicted by arrow 112. In this manner, as depicted by arrow 112, the insert 16 may be removed from or inserted into the recess 86 in a direction parallel with an upward facing surface or upper side 52 of the side shelf 50. In another embodiment, the insert 16 may be removed from or inserted into the recess 86 along a single side of the side shelf 50, as depicted by arrow 112. In a further embodiment, the single side of the side shelf 50 may be the front side 56 of the side shelf 50.

With the insert 16 being the cutting board 88, a hand hold 110 may be defined in the cutting board or in the preparation surface 20 of the cutting board sized and configured for a user to grab onto. The hand hold 110 may also provide assistance when removing the insert 16, or cutting board 88, into and out of the recess 86. Further, the hand hold 110 may be positioned near the insert periphery 108 such that the hand hold 110 may be positioned near the front 90 of the recess 86 when the insert 16 may be positioned therein. Even further, the hand hold 110 being positioned at the front recess side 90 of the recess 86 may allow for the insert 16 to be easily removable by pulling the hand hold 110 and sliding the insert 16 out of the recess 86, and, as such, the insert may also be easily insertable by pushing the insert 16 into the recess, as depicted by arrow 112.

Upon the insert 16 being either partially removed or completely removed from the recess 86, the recess 86 in the side shelf 50 may exhibit a lower opening 114. The lower opening 114 may be defined by the lower wall 104 of the recess 86 extending along the front recess side 90, rear recess side 92, left recess side 94, and right recess side 96 of the recess 86. The lower wall 104 may be coupled to the rear wall 98, left wall 100, right wall 102 of the recess 86 and the front side 56 of the side shelf 50. As such, the lower opening 114 may be configured to allow for unwanted or unused food to be pushed therethrough to a trash bag or bin positioned below the side shelf system 14. In a further embodiment, the insert 16 may include the cutting board 88 and the bin, where unwanted or unused food may be pushed from the cutting board 88 through the lower opening 114 to the bin positioned below, or alternatively into a waste bag positioned below the shelf 50. With this arrangement, the side shelf system 14 may be moved in various orientations, such as a compact or storage position or the use position, without the insert 16 inadvertently falling from the shelf 50. Further, the insert may be partially slid relative to the shelf or fully removed from the shelf 50 to facilitate discarding items from the insert 16 and to readily facilitate cleaning the insert 16.

The various structural components of the embodiments of the cooking station 10 set forth herein may be formed from metallic materials, such as stainless steel, aluminum, copper, or any other suitable metallic material as well as any other materials needed to form and manufacture the various components of the cooking station 10, as known by one of ordinary skill in the art. Further, the structural components of the cooking station 10 may be formed by employing known manufacturing techniques and processes, such as welding, molding, milling, drilling, bending, fastening, soldering, etc., as known to one of ordinary skill in the art.

While the invention may be susceptible to various modifications and alternative forms, specific embodiments have been shown by way of example in the drawings and have been described in detail herein. Further, the structural features of any one embodiment disclosed herein may be combined or replaced by any one of the structural features of another embodiment set forth herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. A side shelf system for coupling to a portable outdoor cooking station, comprising:
a side shelf including a main wall, a front side wall, a rear side wall, an outer side wall and an inner side wall, the inner side wall sized and configured to be pivotably coupled to the cooking station such that the side shelf is moveable between a use position and a pivoted position, the main wall extending to define a recess therein such that, upon the side shelf being in the use position, the main wall extends to define an upper surface and an underside surface, the underside surface including a wall extending directly downward from the underside surface and adjacently along portions of the recess so as to be set-back from a free end of the main wall that defines the recess, the wall including a ledge extending from the wall such that the ledge extends inward to extend substantially parallel with the underside surface of the main wall and adjacently below the free end; and
an insert sized and configured to be positioned within the recess so as to be positioned over the ledge and below the free end of the main wall, the insert configured to be slidably removed from the side shelf in a direction parallel with the upper surface.

2. The side shelf system of claim 1, wherein the side shelf is configured to facilitate the insert being removed from, or inserted into, the recess along a single side of the side shelf.

3. The side shelf system of claim 2, wherein the front side wall is the single side of the side shelf.

4. The side shelf system of claim 1, wherein the recess is sized and configured to retain the insert in the use position and the pivoted position.

5. The side shelf system of claim 1, wherein, upon the insert being positioned in the recess, the ledge and the main wall are positioned along opposite sides of the insert.

6. The shelf system of claim 1, wherein the insert is at least one of a cutting board and a bin.

7. A cooking station, comprising:
a main body having a framework and panels extending between an upper side and a lower side, the main body configured to support one or more heating elements therein for heating a cooking surface supported adjacent the upper side of the main body;
a side shelf including a main wall, a front side wall, a rear side wall, an outer side wall and an inner side wall, the inner side wall sized and configured to be pivotably coupled to the cooking station such that the side shelf is moveable between a use position and a pivoted position, the main wall extending to define a recess therein such that, upon the side shelf being in the use position, the main wall extends to define an upper surface and an underside surface, the underside surface including a wall extending directly downward from the underside surface and adjacently along portions of the recess so as to be set-back from a free end of the main wall that defines the recess, the wall including a ledge extending from the wall such that the ledge extends inward to extend substantially parallel with the underside surface of the main wall and adjacently below the free end; and
an insert sized and configured to be positioned within the recess so as to be positioned over the ledge and below the free end of the main wall, the insert configured to be slidably removed from the side shelf in a direction parallel with the upper surface.

8. The cooking station of claim 7, wherein the side shelf is configured to facilitate the insert being removed from, or inserted into, the recess along a single side of the side shelf.

9. The cooking station of claim 8, wherein the front side wall is the single side of the side shelf.

10. The cooking station of claim 7, wherein the recess is sized and configured to retain the insert in the use position and the pivoted position.

11. The cooking station of claim 7, wherein, upon the insert being positioned in the recess, the ledge and the main wall are positioned along opposite sides of the insert.

12. The cooking station of claim 7, wherein the insert is at least one of a cutting board and a bin.

13. A method for retaining portions of a side shelf system, the method comprising:
providing an outdoor cooking station with a main body, the main body including a side shelf coupled thereto, the side shelf defining an upper side and a lower side, the upper side including a recess defined therein, the recess extending from the upper side to the lower side to define containment walls; and
sliding an insert into the recess in a direction parallel to the upper side of the side shelf and along a front side of the side shelf such that the containment walls retain the insert within the recess, upon the side shelf being moved between a use position and a pivoted position.

14. The method according to claim 13, wherein the sliding comprises moving the insert between a ledge and the upper side of the side shelf such that the ledge and upper side of the side shelf is positioned along opposite sides of the insert.

15. The method according to claim 13, wherein the sliding comprises removing or inserting the insert into the recess along a single side of the side shelf.

16. The method according to claim 13, further comprising pivoting the side shelf to a pivoted position while maintaining the insert in the recess of the side shelf.

17. The method according to claim 13, wherein the sliding an insert comprises positioning a flange portion of a bin within the recess of the side shelf.

18. The method according to claim 13, wherein the sliding an insert comprises positioning at least one of a cutting board and a bin at least partially within the recess of the side shelf.
